(19) United States
(12) Patent Application Publication
(10) Pub. No.: US 2016/0375940 A1
(43) Pub. Date: Dec. 29, 2016

(54) VEHICLE CONFIGURATION MEMBER AND WOVEN FABRIC FOR MOLDING A VEHICLE CONFIGURATION MEMBER

(71) Applicant: TOYOTA JIDOSHA KABUSHIKI KAISHA, Toyota-shi (JP)

(72) Inventors: Hiromasa TOMIOKA, Nagoya-shi (JP); Ryohei TSUJI, Kariya-shi (JP)

(73) Assignee: TOYOTA JIDOSHA KABUSHIKI KAISHA, Toyota-shi (JP)

(21) Appl. No.: 15/090,167

(22) Filed: Apr. 4, 2016

(30) Foreign Application Priority Data
Jun. 24, 2015 (JP) 2015-126556

(51) Int. Cl. B62D 29/04; B32B 3/26; B62D 25/06; B32B 5/02

(52) U.S. Cl. CPC B62D 29/043; B32B 5/024; B32B 3/26; B62D 25/06; B32B 2605/08

(57) ABSTRACT

A vehicle configuration member comprising a base material formed using a resin material; and a woven fabric that is formed by interweaving a plurality of warp threads and a plurality of weft threads, that is covered by the base material so as to reinforce the base material, and that includes a join portion and a pair of branch portions branching out from the join portion. The number of the weft threads bound by a pair of warp threads at an end portion of the join portion on a branch portion side is smaller than the number of the weft threads bound by a pair of warp threads at a location of the join portion on a side away from the branch portions.

### CROSS-REFERENCE TO RELATED APPLICATION

This application claims priority under 35 USC 119 from Japanese Patent Application, No. 2015-126556 filed Jun. 24, 2015, the disclosure of which is incorporated by reference herein in its entirely.

### BACKGROUND

Technical Field

Preferred embodiments relate to a vehicle configuration member and a woven fabric for molding a vehicle configuration member.

Related Art

JP No. S62-97938A describes a woven fabric for 3D-molding that is employed in a composite material, such as a fiber reinforced plastic. The 3D-molding woven fabric is formed including an upper split portion and a lower split portion that are each formed by interweaving warp threads and weft threads. A join portion is provided by joining a portion of the upper split portion and a portion of the lower split portion together using a tie thread. The 3D-molding woven fabric including the upper split portion, the lower split portion, and the join portion is opened out into a specific 3D shape and covered by a resin material so as to form a composite material in a specific shape.

However, it is conceivable that, when external force is applied to the composite material, end portions on the upper split portion and lower split portion sides of the join portion of the 3D-molding woven fabric may become points of failure in the composite material that has portions where the upper split portion and the lower split portion branch from the join portion.

### SUMMARY

In consideration of the above circumstances, an object of preferred embodiments is to provide a vehicle configuration member and a woven fabric for molding a vehicle configuration member that are capable of suppressing an end portion of the join portion on a branch portion side, this being a portion branching from the join portion, from becoming a point of failure.

A vehicle configuration member of a first aspect of the disclosure includes: a base material formed using a resin material; and a woven fabric that is formed by interweaving plural warp threads and plural weft threads, that is covered by the base material so as to reinforce the base material, and that includes a join portion and a pair of branch portions branching out from the join portion, wherein the number of the weft threads bound by a pair of warp threads at an end portion of the join portion on a branch portion side is smaller than the number of the weft threads bound by a pair of warp threads at a location of the join portion on a side away from the branch portions.

In the first aspect, the vehicle configuration member is made from the woven fabric that is formed by interweaving plural warp threads and plural weft threads and that is covered by the base material. The woven fabric forming a portion of the vehicle configuration member of the first aspect includes a join portion and branch portions branching out from the join portion. Now to explain the configuration of the join portion, there are specific numbers of the weft threads that are bound by respective pairs of warp threads. The number of the weft threads bound by a pair of warp threads at an end portion of the join portion on a branch portion side is smaller than the number of the weft threads bound by a pair of warp threads at a location of the join portion on a side away from the branch portions. Namely, the strength of the end portion of the join portion on the branch portion side is higher than the strength at a location of the join portion on the side away from the branch portions. This thereby enables the end portion of the join portion on the branch portion side to be suppressed from becoming a point of failure when external force is applied to the vehicle configuration member made including the woven fabric of the present aspect.

A vehicle configuration member of a second aspect of the disclosure is the vehicle configuration member of the first aspect, wherein the woven fabric includes a closed cross-section portion, and the closed cross-section portion includes the branch portions.

In the second aspect, the strength of the end portion on the branch portion side of the join portion of the woven fabric is raised to higher than that at other locations of the join portion. This thereby enables the end portion of the join portion on the branch portion side to be suppressed from becoming a point of failure while making the overall strength and rigidity of the vehicle configuration member less liable to be affected.

A woven fabric for molding a vehicle configuration member of a third aspect of the disclosure includes plural warp threads that are interwoven with plural weft threads; and a join portion and a pair of branch portions branching out from the join portion, wherein the number of the weft threads bound by a pair of warp threads at an end portion of the join portion on a branch portion side is smaller than the number of the weft threads bound by a pair of warp threads at a location of the join portion on a side away from the branch portions.

In the third aspect, the strength of the end portion of the join portion on the branch portion side of the woven fabric, that is employed for molding the vehicle configuration member, is raised to higher than that of other locations of the join portion. This thereby enables the end portion of the join portion on the branch portion side to be suppressed from coming apart when the woven fabric is opened out into a specific shape. In the present aspect, the end portion of the join portion on the branch portion side is thereby capable of being suppressed from becoming a point of failure when external force is applied to the vehicle configuration member made including the woven fabric.

A vehicle configuration member of a fourth aspect of the disclosure is the vehicle configuration member of the first aspect, wherein the end portion of the join portion on the branch portion side is adjacent to the branch portion.

A woven fabric for molding a vehicle configuration member of a fifth aspect of the disclosure is the woven fabric of the third aspect, wherein the end portion of the join portion on the branch portion side is adjacent to the branch portion.

In the fourth aspect and the fifth aspect, the end portion of the join portion on the branch portion side of the woven fabric is thereby capable of being suppressed from becoming a point of failure when external force is applied to the vehicle configuration member made including the woven fabric.

The vehicle configuration member and the woven fabric for molding the vehicle configuration member according to the disclosure have the excellent advantageous effect of enabling the end portion of the join portion on the branch portion side, this being a portion branching from the join portion, to be suppressed from becoming a point of failure.

### BRIEF DESCRIPTION OF THE DRAWINGS

Preferred embodiments will be described in detail based on the following figures, wherein:

FIG. 1 is a view illustrating a cross-section of a roof side rail body;

FIG. 2 is a perspective view of a vehicle viewed obliquely from the front side;

FIG. 3 is a cross-section illustrating a carbon fiber woven fabric for configuring a portion of the roof side rail; and

FIG. 4 is a cross-section corresponding to FIG. 1 and illustrating a roof side rail of another embodiment.

### DETAILED DESCRIPTION

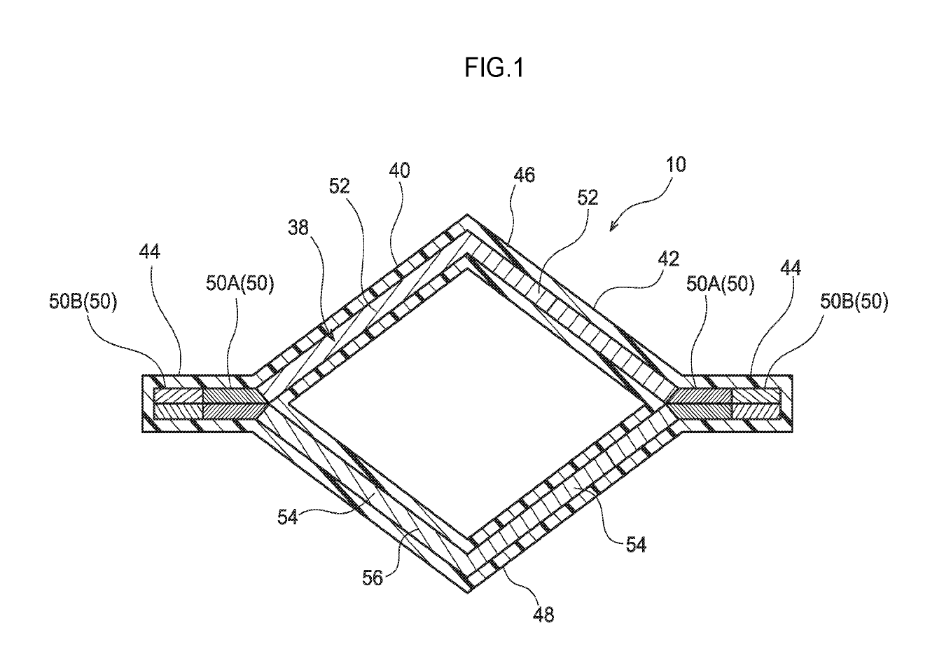

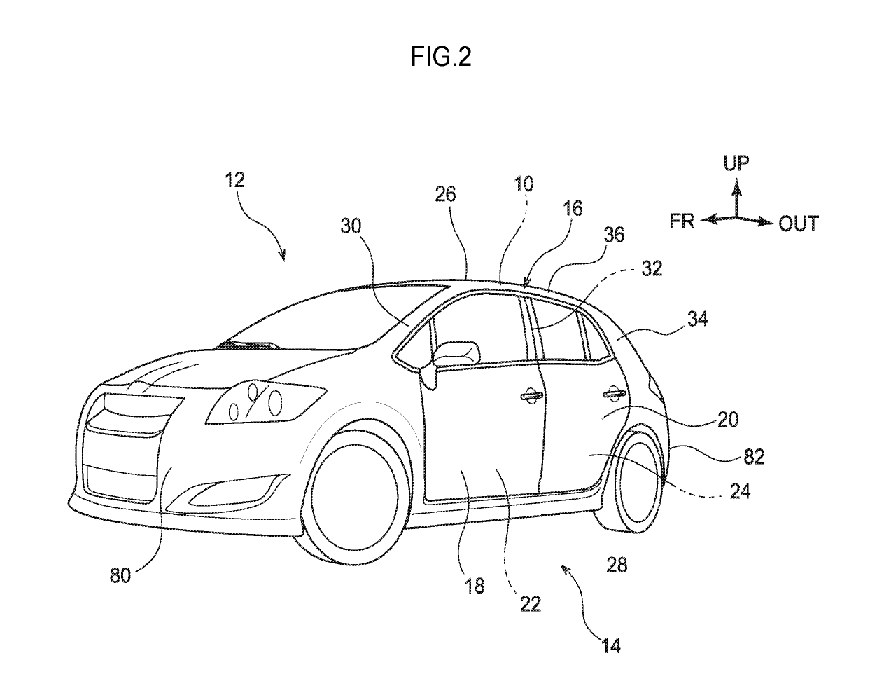

Explanation follows regarding a vehicle configuration member according to an exemplary embodiment of the present invention, with reference to FIG. 1 to FIG. 3. Note that the arrow FR, the arrow UP, and the arrow OUT illustrated in FIG. 2 respectively indicate the vehicle front direction (the direction of travel), the upward direction, and the outside in the vehicle width direction. Hereafter, unless specifically stated otherwise, explanation simply to the front-rear, left-right, and up-down directions refers to front-rear in the vehicle front-rear direction, left-right in the vehicle left-right direction (vehicle width direction), and up-down in the vehicle up-down direction.

As illustrated in FIG. 1, a roof side rail body 10, serving as a vehicle configuration member of the present exemplary embodiment, configures a portion of a roof side rail 16 of a side portion 14 of a vehicle body 12, as illustrated in FIG. 2. First, explanation follows regarding overall configuration of the side portion 14 of the vehicle body 12. Next, explanation follows regarding the roof side rail body 10, this being a relevant portion of the present exemplary embodiment.

The vehicle body 12 of the present exemplary embodiment configures what is known as a hatchback type of vehicle, and the side portion 14 of the vehicle body 12 is formed with a front side door opening 22 and a rear side door opening 24 which are opened and closed by a front side door 18 and a rear side door 20.

The front side door opening 22 is formed by the roof side rail 16 extending along the vehicle front-rear direction at an end portion at the vehicle width direction outside of a roof 26 of the vehicle body 12, a rocker 28 extending along the vehicle front-rear direction at an end portion at the vehicle width direction outside of a floor of the vehicle body 12, a front pillar 30 that links a front end portion of the roof side rail 16 and a front end portion of the rocker 28 together in the up-down direction, a center pillar 32 that links a front-rear direction intermediate portion of the roof side rail 16 and a front-rear direction intermediate portion of the rocker 28 together in the up-down direction, and the like. The rear side door opening 24 is formed by the roof side rail 16, the rocker 28, the center pillar 32, a rear pillar 34 that links a rear end portion of the roof side rail 16 and a rear end portion of the rocker 28 together in the up-down direction, and the like. The front side door opening 22 and the rear side door opening 24 are opened and closed off by the front side door 18 and the rear side door 20, thereby enabling an occupant to board the vehicle, and enabling an occupant to alight from the vehicle.

The roof side rail 16 is configured by, for example, joining an outer panel 36 configuring an external design portion of a vehicle to the roof side rail body 10 (see FIG. 1). Note that the rocker 28, the front pillar 30, the center pillar 32, and the rear pillar 34 are, similarly to the roof side rail 16, configured including framework members corresponding to the roof side rail body 10.

As illustrated in FIG. 1, the roof side rail body 10 is a composite material (a carbon fiber reinforced plastic (CFRP)) formed by covering a carbon fiber woven material 38, serving as a woven material, with a plastic material 40, serving as a base material formed by using a resin material so as to encapsulate the carbon fiber woven material 38 inside the plastic material 40. The roof side rail body 10 extends along the vehicle front-rear direction and is formed in a gently curving elongated shape corresponding to the shape of the roof 26 (see FIG. 2) of the vehicle body 12.

The roof side rail body 10 includes a closed cross-section portion 42 configuring in cross-section a substantially rhomboid shaped closed cross-section (the cross-section illustrated in FIG. 1) sectioned along a direction perpendicular to the length direction of the roof side rail body 10, and a pair of flanges 44 extending from the closed cross-section portion 42. The closed cross-section portion 42 includes a closed cross-section first configuration portion 46 bent into a shape protruding toward one side, and a closed cross-section second configuration portion 48 formed into a shape protruding toward the opposite side to the closed cross-section first configuration portion 46. One of the flanges 44 extends, from a merging portion between an end portion on one side of the closed cross-section first configuration portion 46 and an end portion on one side of the closed cross-section second configuration portion 48, toward a direction away from the closed cross-section portion 42. Moreover, the other of the flanges 44 extends, from a merging portion between an end portion on the other side of the closed cross-section first configuration portion 46 and an end portion on the other side of the closed cross-section second configuration portion 48, toward a direction away from the closed cross-section portion 42, and toward the opposite direction to that of the one flange 44.

A carbon fiber woven fabric 38 is formed with a closed cross-section profile corresponding to the shape of the roof side rail body 10, and the carbon fiber woven fabric 38 is encapsulated inside the plastic material 40 so as to reinforce the plastic material 40. More specifically, the carbon fiber woven fabric 38 includes a pair of join portions 50 that are respectively disposed inside the pair of flanges 44 of the roof side rail body 10, and a first branch portion 52 and a second branch portion 54 that branch from the join portions 50 and serve as branch portions respectively disposed inside the closed cross-section first configuration portion 46 and the closed cross-section second configuration portion 48 of the roof side rail body 10. The first branch portion 52 extending from the join portion 50 on one side and the first branch portion 52 extending from the join portion 50 on the other side are linked together, and the second branch portion 54 extending from the join portion 50 on the one side and the second branch portion 54 extending from the join portion 50 on the other side are linked together. The first branch portion 52 on the one side, the first branch portion 52 on the other side, the second branch portion 54 on the one side, and the second branch portion 54 on the other side thereby form a closed cross-section portion 56 of a substantially rhomboid shape.

In the present exemplary embodiment, end portions 50A on the first branch portion 52 side and second branch portion 54 side of the join portions 50 are interwoven with a higher weave density than locations 50B on the sides away from the first branch portion 52 and the second branch portion 54. The strength of the end portions 50A on the first branch portion 52 side and second branch portion 54 side of the join portions 50 is accordingly a higher strength than the strength of the locations 50B on the sides away from the first branch portion 52 and the second branch portion 54. Note that weave density refers to the degree of binding of the warp threads by the weft threads, and the lower the thread count of the weft threads disposed between a pair of warp threads, described later, the stronger the binding of the weft threads by the warp threads, and the higher the weave density.

A more detailed explanation follows regarding a configuration of the carbon fiber woven fabric 38.

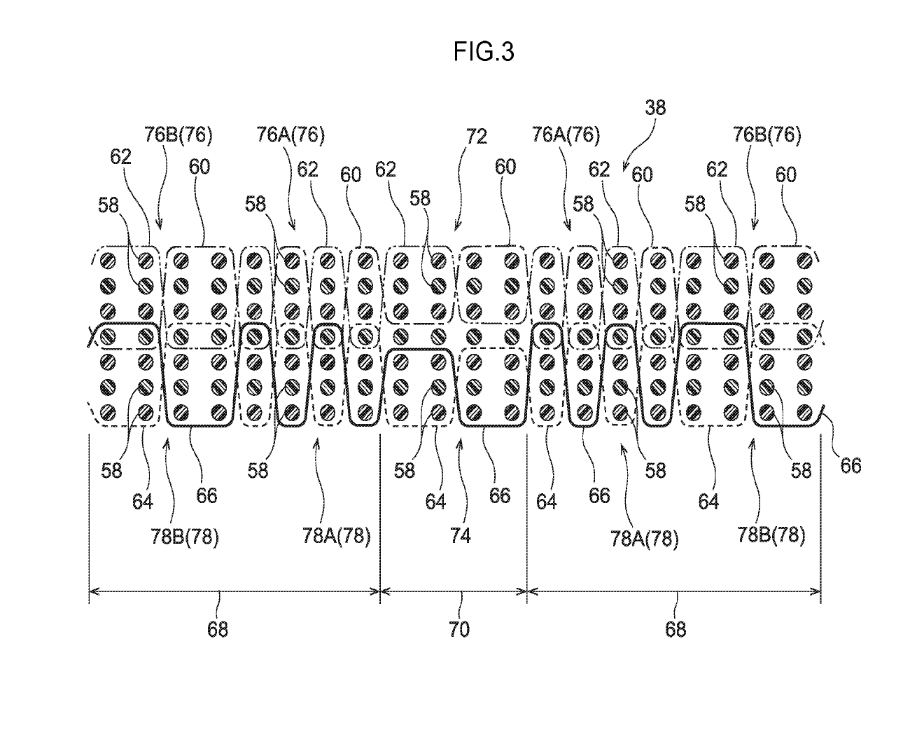

As illustrated in FIG. 3, the carbon fiber woven fabric 38 is formed by interweaving plural weft threads 58 extending along the length direction of the roof side rail body 10 (see FIG. 1), and plural first warp threads 60, second warp threads 62, third warp threads 64, and fourth warp threads 66, serving as warp threads extending in a direction perpendicular to the extension direction of the weft threads 58. Note that FIG. 3 illustrates four warp threads (the first warp thread 60, the second warp thread 62, the third warp thread 64, and the fourth warp thread 66); however, in the actual carbon fiber woven fabric 38, plural warp threads corresponding to the first warp thread 60, the second warp thread 62, the third warp thread 64, and the fourth warp thread 66 are arrayed along the length direction of the roof side rail body 10.

The carbon fiber woven fabric 38 of the present exemplary embodiment is an integrated woven fabric (a single woven fabric) interwoven with locations 68 configuring the join portions 50 (see FIG. 1), and a location 70 configuring the closed cross-section portion 56 (see FIG. 1), having different forms to each other. This thereby, by opening out the interwoven carbon fiber woven fabric 38, enables the cross-section profile of the carbon fiber woven fabric 38 to be a shape corresponding to the cross-section profile of the roof side rail body 10.

The location 70 of the carbon fiber woven fabric 38 configuring the closed cross-section portion 56 includes a first branch configuration portion 72 forming a portion corresponding to the first branch portion 52 (see FIG. 1) by interweaving twelve of the weft threads 58 with the first warp thread 60 and the second warp thread 62. In the first branch configuration portion 72, six of the weft threads 58 are bound by the first warp thread 60 and the second warp thread 62 by disposing the six weft threads 58 between the first warp thread 60 and the second warp thread 62.

The location 70 configuring the closed cross-section portion 56 also includes a second branch configuration portion 74 forming a portion corresponding to the second branch portion 54 (see FIG. 1) by interweaving twelve of the weft threads 58 with the third warp thread 64 and the fourth warp thread 66. In the second branch configuration portion 74, similarly to in the first branch configuration portion 72, six of the weft threads 58 are bound by the third warp thread 64 and the fourth warp thread 66 by disposing the six weft threads 58 between the third warp thread 64 and the fourth warp thread 66.

Moreover, in the present exemplary embodiment, the first branch configuration portion 72 and the second branch configuration portion 74 are separated due to the weft threads 58 not being disposed between either one of the first warp thread 60 and the second warp thread 62 and either one of the third warp thread 64 and the fourth warp thread 66. This thereby enables the closed cross-section portion 56 (see FIG. 1) to be formed, from the first branch configuration portion 72 and the second branch configuration portion 74, in a substantially rhomboid shape when the carbon fiber woven fabric 38 is opened out.

The location 68 of the carbon fiber woven fabric 38 configuring the join portion 50 includes a first layer configuration portion 76, this being the upper half side in the drawings, formed by interweaving thirty-two of the weft threads 58 with the first warp thread 60 and the second warp thread 62. The first layer configuration portion 76 is linked to the first branch configuration portion 72. At the location 76B of the first layer configuration portion 76 on the opposite side to the first branch configuration portion 72, eight of the weft threads 58 are bound by the first warp thread 60 and the second warp thread 62 by disposing eight of the weft threads 58 between the first warp thread 60 and the second warp thread 62. At the location 76A on the first branch configuration portion 72 side of the first layer configuration portion 76, four of the weft threads 58 are bound by the first warp thread 60 and the second warp thread 62 by disposing four of the weft threads 58 between the first warp thread 60 and the second warp thread 62.

The location 68 of the carbon fiber woven fabric 38 configuring the join portion 50 includes a second layer configuration portion 78, this being the lower half side in the drawings, formed by interweaving thirty-two of the weft threads 58 with the third warp thread 64 and the fourth warp thread 66. The second layer configuration portion 78 is linked to the second branch configuration portion 74. At a location 78B of the second layer configuration portion 78 on the opposite side to the second branch configuration portion 74, eight of the weft threads 58 are bound by the third warp thread 64 and the fourth warp thread 66 by disposing eight of the weft thread 58 between the third warp thread 64 and the fourth warp thread 66. At a location 78A of the second layer configuration portion 78 on the second branch configuration portion 74 side, four of the weft threads 58 are bound by the third warp thread 64 and the fourth warp thread 66 by disposing four weft threads 58 between the third warp thread 64 and the fourth warp thread 66.

Moreover, in the present exemplary embodiment, the weft threads 58 are disposed between the first warp thread 60 and the third warp thread 64, and between the second warp thread 62 and the fourth warp thread 66, thereby binding the weft thread 58 with these warp threads such that the first layer configuration portion 76 and the second layer configuration portion 78 are integrally interwoven together. In the present exemplary embodiment, the number of the weft thread 58 disposed between warp threads, such as the first warp thread 60 and the third warp thread 64, and the second warp thread 62 and the fourth warp thread 66, at the locations 76A, 78A of the first layer configuration portion 76 and the second layer configuration portion 78 on the first branch configuration portion 72 side and the second branch configuration portion 74 side, is set so as to be fewer than the number of the weft threads 58 disposed between warp threads at the locations 76B, 78B on the opposite side to the first branch configuration portion 72 and the second branch configuration portion 74. Note that in the present exemplary embodiment, the number of the weft threads 58 disposed between the first warp thread 60 and third warp thread 64, and disposed between the second warp thread 62 and the fourth warp thread 66, at the locations 76A, 78A on the first branch configuration portion 72 side and second branch configuration portion 74 side, is one. Moreover, the number of the weft threads 58 disposed between the first warp thread 60 and third warp thread 64, and between the second warp thread 62 and the fourth warp thread 66, at the locations 76B, 78B on the opposite side to the first branch configuration portion 72 and the second branch configuration portion 74, is two.

In the opened out state of the carbon fiber woven fabric 38 explained above, the carbon fiber woven fabric 38 is disposed inside a specific mold. The carbon fiber woven fabric 38 is disposed inside the plastic material 40 by introducing the plastic material 40 into an evacuated mold, followed by heating and then cooling. The roof side rail body 10 illustrated in FIG. 1 is thereby formed.

Operation and Advantageous Effects of the Present Exemplary Embodiment

Explanation follows regarding operation and advantageous effects of the present exemplary embodiment.

The shape of the closed cross-section portion 42 of the roof side rail body 10 deforms when external force due to a collision or the like acts on the vehicle body 12 illustrated in FIG. 2 and the external force is transmitted to the roof side rail body 10 configuring a portion of the vehicle body 12. The closed cross-section portion 56 of the carbon fiber woven fabric 38 accordingly also deforms. In particular, when force is input in a direction to compress the roof side rail body 10 along its length direction, the closed cross-section portion 42 of the roof side rail body 10 and the closed cross-section portion 56 of the carbon fiber woven fabric 38 deform so as to widen. When this occurs, it is conceivable that the end portions 50A at the first branch portion 52 side and second branch portion 54 side of the join portions 50 of the carbon fiber woven fabric 38 might become points of failure, and the roof side rail body 10 might be broken.

However, in the present exemplary embodiment, the end portions 50A on the first branch portion 52 side and the second branch portion 54 side of the join portions 50 are interwoven with a higher weave density than the locations 50B on the side of the join portions 50 away from the first branch portion 52 and the second branch portion 54. The strength of the end portions 50A on the first branch portion 52 side and the second branch portion 54 side of the join portions 50 is accordingly a higher strength than the strength of the locations 50B on the side away from the first branch portion 52 and the second branch portion 54. As a result, when external force imparted to the vehicle body 12 is transmitted to the roof side rail body 10, the roof side rail body 10 can be suppressed from being broken at about the end portions 50A, that are provided on the first branch portion 52 side and the second branch portion 54 side of the join portions 50 of the carbon fiber woven fabric 38, as the points of failure.

In the present exemplary embodiment, the strength at only the end portions 50A on the first branch portion 52 side and the second branch portion 54 side of the join portions 50 is configured to be stronger than other locations of the join portions 50. Namely, configuration is not made to raise the overall strength of the join portions 50. This thereby enables the roof side rail body 10 to be suppressed from being broken at about the end portions 50A, as points of failure, of the first branch portion 52 side and second branch portion 54 side of the join portions 50 of the carbon fiber woven fabric 38, while making the overall strength and rigidity of the roof side rail body 10 less liable to be affected.

In the present exemplary embodiment, the end portions 50A on the first branch portion 52 side and the second branch portion 54 side of the join portions 50 can be suppressed from coming apart when the carbon fiber woven fabric 38 is being opened out. This thereby enables the quality of the roof side rail body 10 configured including the carbon fiber woven fabric 38 to be stabilized.

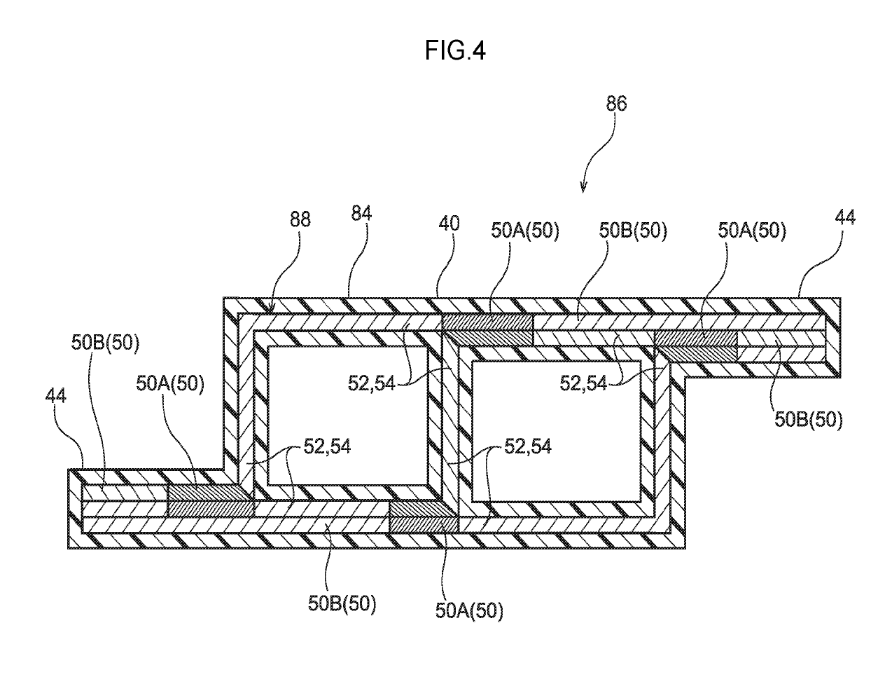

Note that in the present exemplary embodiment, explanation has been given regarding an example of the present embodiment applied to the roof side rail body 10 having the closed cross-section portion 42; however, the present invention is not limited thereto. For example, the present invention may be applied to a vehicle configuration member with an H cross-section or Y cross-section. As illustrated in FIG. 4, the present invention may be applied to a vehicle configuration member 86 having a closed cross-section 84 formed in a lattice. Note that portions of a carbon fiber woven fabric 88, serving as the woven fabric configuring the vehicle configuration member 86 or a portion of the vehicle configuration member 86 (portions of similar configuration thereto) that correspond to the roof side rail body 10, illustrated in FIG. 1, are appended with the same reference numerals as in the roof side rail body 10.

In the present exemplary embodiment, explanation has been given regarding an example in which the carbon fiber woven fabric 38 is formed using the weft threads 58, the first warp thread 60, the second warp thread 62, the third warp thread 64, and the fourth warp thread 66; however, the present invention is not limited thereto. The number of weft threads and warp threads, the angles formed between the weft threads and the warp threads, the diameter of the weft threads and the warp threads, the material of the weft threads and the warp threads, and the like may be applicably set in consideration of the strength, rigidity, and the like required by the vehicle configuration member.

In the present exemplary embodiment, explanation has been given regarding an example of the present embodiment applied to the roof side rail body 10, this being a framework member of the roof side rail 16; however, the present invention is not limited thereto. For example, the present invention may be applied to the framework members of the rocker 28, the front pillar 30, the center pillar 32, and the rear pillar 34 illustrated in FIG. 2. The present invention may be applied to bumper reinforcement disposed within a front bumper 80 or rear bumper 82, not illustrated in the drawings.

Explanation has been given above regarding an exemplary embodiment of the present invention; however, the present invention is not limited to the above, and obviously various other modifications may be implemented within a range not departing from the spirit of the present invention.

What is claimed is:

1. A vehicle configuration member comprising:
a base material formed using a resin material; and
a woven fabric being formed by interweaving a plurality of warp threads and a plurality of weft threads, being covered by the base material so as to reinforce the base material, and including a join portion and a pair of branch portions branching out from the join portion,
wherein the number of the weft threads bound by a pair of warp threads at an end portion of the join portion on a branch portion side is smaller than the number of the weft threads bound by a pair of warp threads at a location of the join portion on a side away from the branch portions.

2. The vehicle configuration member of claim 1, wherein:
the woven fabric includes a closed cross-section portion; and
the closed cross-section portion includes the branch portions.

3. A woven fabric for molding a vehicle configuration member, comprising:
a plurality of warp threads interwoven with a plurality of weft threads; and
a join portion and a pair of branch portions branching out from the join portion,
wherein the number of the weft threads bound by a pair of warp threads at an end portion of the join portion on a branch portion side is smaller than the number of the weft threads bound by a pair of warp threads at a location of the join portion on a side away from the branch portions.

4. The vehicle configuration member of claim 1, wherein the end portion of the join portion on the branch portion side is adjacent to the branch portion.

5. The woven fabric for molding a vehicle configuration member of claim 3, wherein the end portion of the join portion on the branch portion side is adjacent to the branch portion.
